(19) United States
(12) Patent Application Publication
(10) Pub. No.: US 2025/0278522 A1
(43) Pub. Date: Sep. 4, 2025

(54) PROVIDING CONFIGURATION INFORMATION FOR GENERATING PHYSICALLY OBFUSCATED INFORMATION ON A CHIP

(71) Applicant: Infineon Technologies AG, Neubiberg (DE)

(72) Inventor: Thomas Kuenemund, Muenchen (DE)

(21) Appl. No.: 19/063,734

(22) Filed: Feb. 26, 2025

(30) Foreign Application Priority Data
Mar. 4, 2024 (DE) 102024106156.1

(51) Int. Cl. G06F 21/73; G06F 21/75

(52) U.S. Cl. CPC G06F 21/73; G06F 21/75

(57) ABSTRACT

A method for providing configuration information for generating physically obfuscated information on a chip with a plurality of circuits, which have a plurality of delay stages, is provided, wherein each delay stage has at least two delay elements, and the method includes determining, for each of the circuits, for each delay stage, which of the delay elements of the delay stage has the least delay among the delay elements of the delay stage, determining configuration information depending on the determined delay elements, which configuration information specifies a configuration of the circuit for each of the circuits, in which the delay elements of different delay stages are connected in series in such a way that at least one path from an input of the circuit to an output of the circuit is formed and storing the determined configuration information.

### TECHNICAL FIELD

Exemplary aspects relate in general to methods for providing configuration information for generating physically obfuscated information on a chip.

### BACKGROUND

The reverse engineering of integrated circuits (ICs), also referred to as “chips”, is considered one of the most serious threats for the semiconductor industry, as it can be misused to copy a design: successful attackers can use and sell similar, i.e. “cloned” ICs. Therefore, techniques are desirable, which make it possible to prevent or at least make the reverse engineering (and specifically the copying or “cloning”) of integrated circuits so difficult that it is no longer profitable. One possibility for this is the use of physically obfuscated information, e.g. physically obfuscated values (“POC values”), which act like a fingerprint of a chip and thus prevent its cloning. However, these should be generated as robustly as possible so that an authentic chip is not incorrectly identified as a clone or so that a complex error correction is not necessary.

### SUMMARY

According to one aspect, a method for providing configuration information for generating physically obfuscated information on a chip (i.e. in an integrated circuit) is provided, wherein the chip has a quantity of circuits which each have a plurality of delay stages, wherein each delay stage has at least two delay elements and wherein the method comprises:

Determining, for each of the circuits, for each delay stage, which of the delay elements of the delay stage has the least delay among the delay elements of the delay stage. (In the case of two delay elements per delay stage, this is equivalent to determining which of the delay elements of the delay stage has the higher delay.)

Determining configuration information depending on the determined delay elements, which configuration information specifies a configuration of the circuit for each of the circuits, in which the delay elements of different delay stages are connected in series in such a way that at least one path is formed (e.g. by means of the determined delay elements) from an input of the circuit to an output of the circuit (e.g. so that the delay elements form a path that in each delay stage leads through the delay element having the least delay among the delay elements of the delay stage; in the case of two delay elements per stage, this is equivalent to configuring the circuit such that the delay elements with the higher delay likewise form a path)

Storing the determined configuration information.

### DESCRIPTION OF THE DRAWINGS

The figures do not reflect the actual proportions, but rather should be used to illustrate the principles of the various exemplary aspects. Various exemplary aspects are described below with reference to the following figures.

FIG. 1 shows a chip card as an example of a device having an IC.

FIG. 2 shows a Schmitt trigger, an example of a delay element.

FIG. 3 shows a POC circuit element with a series connection of two delay stages.

FIG. 4 shows a delay circuit in which, in addition to a delay element, a bypass element is provided in parallel to it.

FIG. 5 shows a POC circuit element with a series connection of two delay stages by means of a multiplexer.

FIG. 6 shows an RS flip-flop 600 based on two NOR gates.

FIG. 7 shows a transmission gate, also referred to as a differential feedback transfer gate.

FIG. 8 shows the behavior over time when the input node pair of the transmission gate of FIG. 7 is switched.

FIG. 9 shows a flowchart that illustrates a method for providing configuration information for generating physically obfuscated information on a chip.

FIG. 10 shows a chip in accordance with one aspect.

### DETAILED DESCRIPTION

The following detailed description refers to the accompanying figures, which show details and exemplary aspects. These exemplary aspects are described in such detail that a person skilled in the art can carry out the aspects of the disclosure. Other aspects are also possible and the exemplary aspects can be changed in structural, logical and electrical terms without departing from the subject matter of the disclosure. The various exemplary aspects are not necessarily mutually exclusive; rather, various aspects can be combined with one another to produce new aspects. In the context of this description, the terms “connected”, “attached” and “coupled” are used to describe both a direct and an indirect connection, a direct or indirect attachment and a direct or indirect coupling.

One promising approach for reliably and securely identifying and authenticating ICs (and thus for preventing the possibility of using copies of ICs instead of original ICs) consists in using so-called physical random functions or physically obfuscated circuits (POCs) for securely generating secret information (e.g. keys for cryptographic algorithms) on the respective chip. Ideally, POCs generate chip-specific keys (i.e. POC values consisting of a certain number of POC bits, e.g. 128 bits) that can be repeated arbitrarily, but cannot be predicted for any chip and cannot be determined from outside the chip. This can be achieved by taking advantage of random variations in the IC manufacturing processes and at the same time generating POC values in such a way that POC value generation remains robust with respect to process fluctuations and is robust with respect to temperature and supply-voltage fluctuations.

As POCs can be integrated on the respective chip together with a special control logic, any attempt to physically access the POC circuit itself can be restricted very effectively and efficiently. This considerable resistance to physical attacks is the main advantage of using controlled POCs on chips.

A POC value P can be thought of as a type of fingerprint of a physical object. On the basis of the true POC value P, i.e. the POC value when it was registered, it is possible to identify the physical object uniquely and e.g. a key can be created on the basis of the identification. The physical object can be a controller or a microcontroller. It can also be a chip card IC (integrated circuit, i.e. chip) of a chip card such as a smart card with any form factor, e.g. for a passport or for a SIM (Subscriber Identity Module).

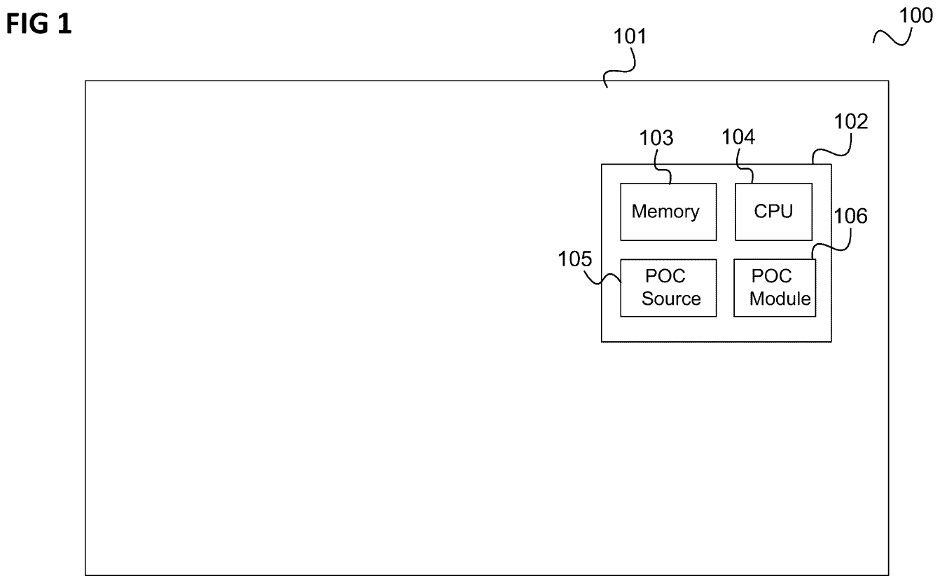

FIG. 1 shows a chip card 100 as an example of a device having an IC (i.e. a chip).

The chip card 100, which is illustrated in card format here, but can have any form factor, has a carrier 101 and a chip card module 102 (i.e. an IC/chip). The chip card module 102 has various components, such as e.g. a non-volatile memory 103 and a CPU (central processing unit) 104. In various aspects, the chip card has a component 105 that serves as a POC source, e.g. a circuit having a multiplicity of subcircuits, wherein an output of a subcircuit specifies one or more bits of a POC value (or is used as the basis for that). The chip card that uses a POC is just one example and can be a device with any type of integrated circuit.

The POC value P can be regarded as an identification number for the chip card 100 (more precisely: for the chip card module 102 in the chip card 100). The chip card module 102 for example has a cryptoprocessor which derives a chip-card-specific cryptographic key from this identification number or the CPU 104 itself derives a cryptographic key from it.

For security reasons, neither the true POC value P nor the cryptographic key that is derived from it is stored on the chip card 100. Instead, a so-called POC module 106, which is connected to the POC source 105, is located on the chip card 100. If the POC value P is required (e.g. for key generation), then a so-called POC request is made to the POC module 106, whereupon the POC module 106 determines the POC value anew (by means of an internal electronic process) in each case. In other words: the POC module 106 responds to a POC request with the output of a POC value P′ which, depending on the bit stability of the bits supplied by the POC source 105, may deviate from the true POC value P, i.e. the POC value at its registration, to a greater or lesser extent. In order to determine the true POC value P from P′, it is possible to carry out error correction, for which auxiliary data can be stored on the chip 100. However, it is desirable that the POC value generation be as robust as possible, so that P′ matches P as well as possible and it is not necessary to provide overly complex error correction and auxiliary data that is too extensive.

According to various aspects, a POC or POC generation is provided, which exhibits high robustness, specifically with respect to voltage and temperature fluctuations. This means that the outlay (in terms of computing time, required chip area, memory, etc.) for error correction can be kept low.

Furthermore, the POC value is generated in such a way that for the correct generation of the POC value (that is, a POC value that matches the true POC value at least for the most part), an IC-specific value, hereinafter referred to as a password, is required. Using this password, the POC value can then be retrieved when using the chip. In the event of an unauthorised access attempt that can be detected on the basis of the fact that there is a strong deviation of the generated POC value from the true POC value and it can therefore be assumed that the attempt has taken place without the correct password, an alarm signal can be output or other safety measures can be taken, e.g. one or more circuits of the IC can be blocked, etc. A verification circuit can therefore be provided on a chip, which is set up to verify whether the generated POC value deviates from the true POC value by more than a specified extent and, if necessary, triggers safety measures (alarm, deactivation of circuit parts or functions, etc.).

According to various aspects, POC generation is based on pairs of delay elements with an identical design (or else quantities with a larger number of delay elements, but pairs are used as an example below), the delays of which (e.g. first delay element: delay τ, second delay element: delay τ′) depend on local process variations (e.g. in that MOSFETs (metal oxide semiconductor field effect transistors) are used with small widths and lengths, e.g. minimum widths and lengths in accordance with the technology used).

As a result, the difference Δτ=ττ′ between the two delay elements varies significantly more strongly than the delays of conventional buffer circuits.

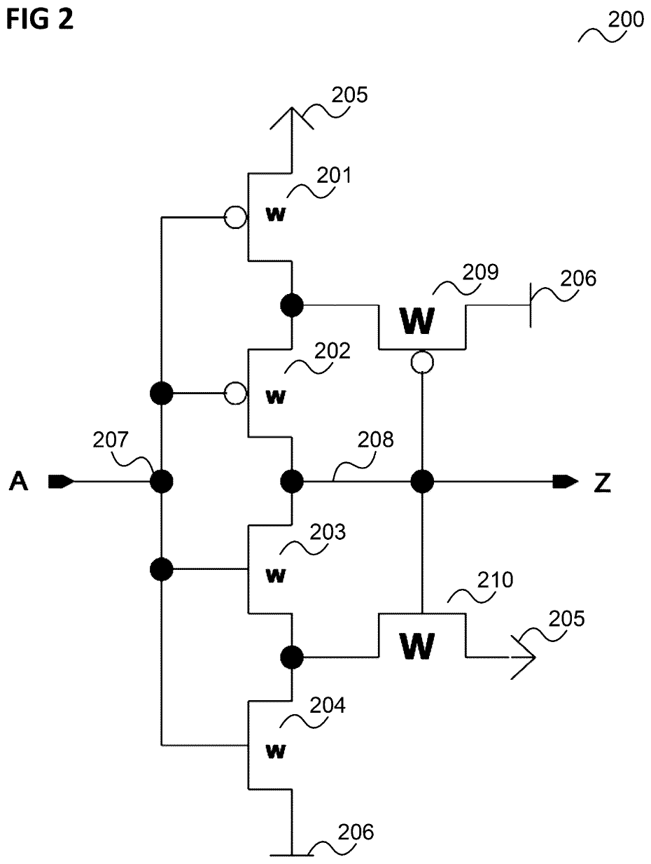

FIG. 2 shows a Schmitt trigger (or also a “Schmitt trigger buffer circuit”) 200, an example of a delay element.

The Schmitt trigger 200 contains two pMOS-(i.e. p-channel MOS)-FETs 201, 202 which are connected in series and which for their part are connected (between a high supply potential 205 and a low supply potential 206) in series, by means of a connection node 208, to two nMOSFETs 203, 204, which are connected in series. The gate of each of the FETs 201-204 is connected to an input 207 (input signal A) of the Schmitt trigger 200. The connection node 208 forms the output of the Schmitt trigger 200 (output signal Z). This is connected to the gate of a third pMOSFET 209 and the gate of a third nMOSFET 210.

The third pMOSFET 209 is connected to the low supply potential 206 using its drain and to the connection node of the pMOSFETs 201, 202, which are connected in series, using its source.

The third nMOSFET 210 is connected to the high supply potential 205 using its drain and to the connection node of the nMOSFETs 203, 204, which are connected in series, using its source.

The pMOSFETs 201, 202 which are connected in series and the nMOSFETs 203, 204 which are connected in series have the same small (e.g. minimum according to the chip manufacturing technology used) widths w (except for process fluctuations), so their properties (across several such Schmitt triggers) vary greatly with process fluctuations. The third pMOSFET 209 and the fourth nMOSFET 210 by contrast have large widths W, so their properties (across several such Schmitt triggers) vary only slightly. Overall, the delay (from a logic level change of the input signal A to a logic level change of the output signal Z) that the Schmitt trigger 200 causes depends on process fluctuations.

Such delay elements, the delays of which are different, are then combined to form pairs (or else sets of more than two delay elements). Each pair forms a delay stage and a plurality (two or more) of such delay stages are connected in series for generating the POC value (by appropriately configured multiplexers or generally “delay element connection circuits”) in such a way that the differences in the delays within the delay stages are superimposed constructively, i.e. so two paths are formed by the delay stages, where the first path for each delay stage contains the delay element with the respective lower delay and the second path for each delay stage contains the delay element with the respective higher delay.

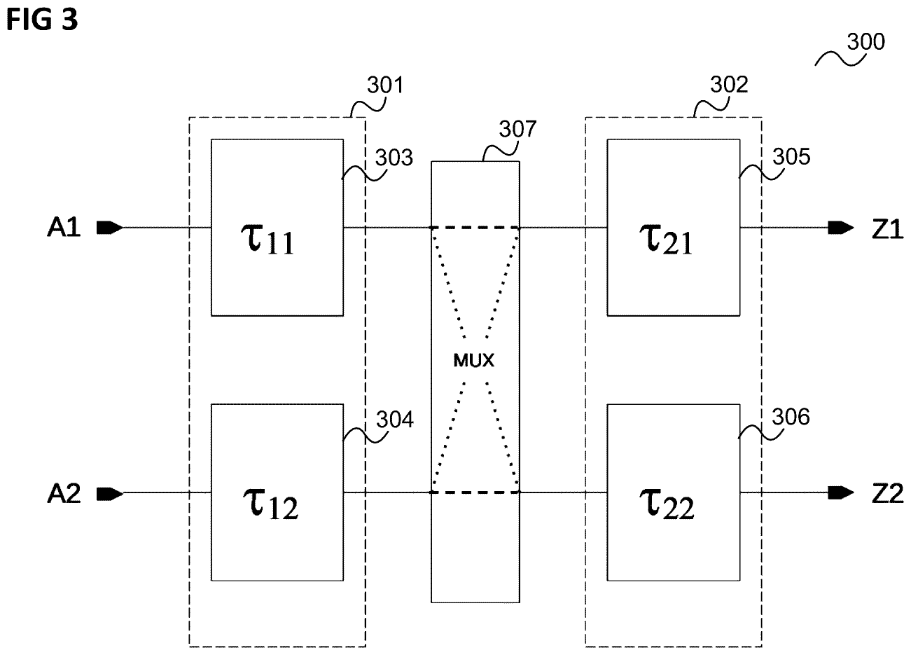

FIG. 3 shows a POC circuit element 300 (e.g. part of the POC source 105) having a series connection, by means of a multiplexer 307, of two delay stages 301, 302, each having two delay elements 303-306.

The individual delays τ₁₁, τ₁₂, τ₂₁, τ₂₂ are not known after the manufacture of the chip which contains the POC circuit element 300 due to the inevitable process fluctuations, but it is possible to determine for each delay stage which delay element has the lower delay, i.e. the signs of the delay differences Δτ₁=τ₁₁−τ₁₂ and Δτ₁=τ₁₁−τ₁₂ can be determined (as described below).

The multiplexer 307 can then be configured (i.e. controlled) accordingly, i.e. a control bit value for the multiplexer 307 can be determined in such a way that it connects the two faster delay elements to one another and connects the two slower delay elements to one another. This control bit value is the control bit value for the multiplexer for this POC circuit element 300 for generating the POC value P′ (which is ideally true, but in practice is affected by errors) and forms the password with the control bit values for further such POC circuit elements, which password can then be used to set the multiplexers to generate the POC value. The POC circuit element 300 and others of its type are therefore used both for the registration of the password (“enrolment”) and later for POC value generation.

In order to be able to determine which delay element of a delay stage has the lower delay, according to an aspect, each delay element is provided with a bypass element, the delay of which varies little with process fluctuations (across the delay elements) and can thus be used to “deactivate” (i.e. make irrelevant) delay differences of individual delay stages, so the sign of the delay difference (i.e. which delay element has the higher delay) of another delay stage can be read out. Thus, instead of the delay elements themselves, delay circuits are used, each of which has a bypass in addition to the delay element.

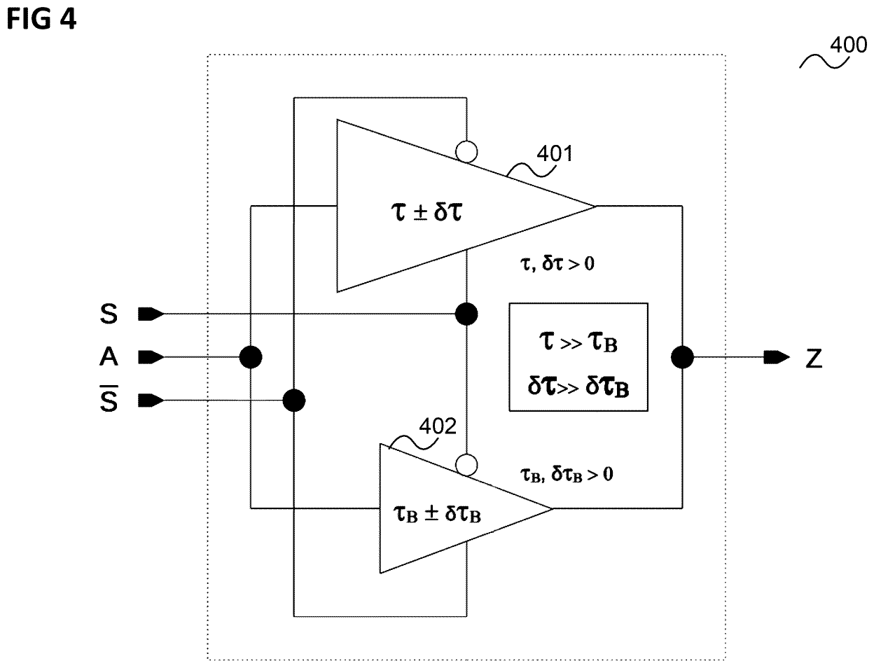

FIG. 4 shows a delay circuit 400, in which, in addition to a delay element 401 (e.g. as described with reference to FIG. 1), a bypass element 402 (which itself is configured e.g. as with reference to FIG. 1, but the delay of which has a low dependence on process fluctuations) is provided in parallel to it.

By means of a control signal S (and the complementary control signal S̅) it is possible to set whether the input signal A is propagated by the delay element 401 or by the bypass element 402. If all the delay elements in a delay stage are set in such a way that the input signals are propagated by the bypass elements (due to the low process-fluctuation dependence of the delay of the bypass elements), the difference in the delay stage is then very small.

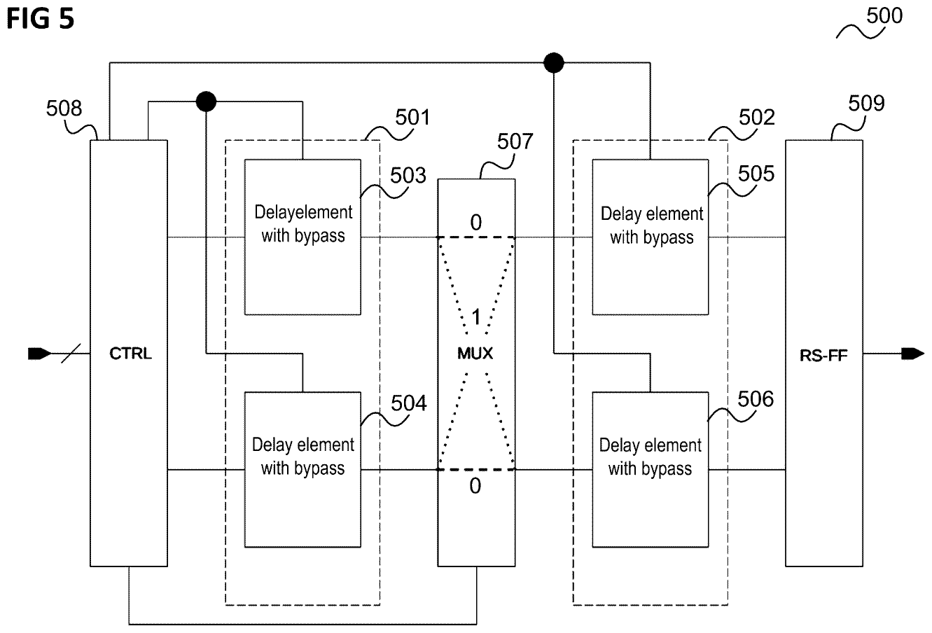

FIG. 5 shows a POC circuit element 500 (e.g. part of the POC source 105) with a series connection of two delay stages 501, 502 by means of a multiplexer 507.

The delay stages 501, 502 each contain two delay circuits 503-506 with bypass, i.e. two delay elements each, which are each provided with a bypass.

In the registration phase, a control circuit 508 sets one of the delay stages to the bypass mode, i.e. in such a way that its input signal (e.g. a signal edge supplied by the control circuit 508 in the case of the first delay stage 501 or by the multiplexer 507 in the case of the second delay stage 502) is propagated through the bypass by both delay circuits. The multiplexer 507 is set to a default setting. Then, by detecting which delay circuit 505, 506 of the second delay stage 502 first supplies the input signal (i.e. the signal edge), it is possible to determine which delay element of the delay stage, which was not switched to the bypass mode, has the lower delay. This is carried out sequentially (successively) for both delay stages (or in the case of POC circuit elements 500 with more than two stages, all but one delay stage are switched to bypass mode to determine which delay element of this delay stage has the lower delay).

The detection of which delay circuit 505, 506 of the second delay stage 502 supplies the input signal (i.e. the signal edge) first can take place for example by means of an RS flip-flop 509.

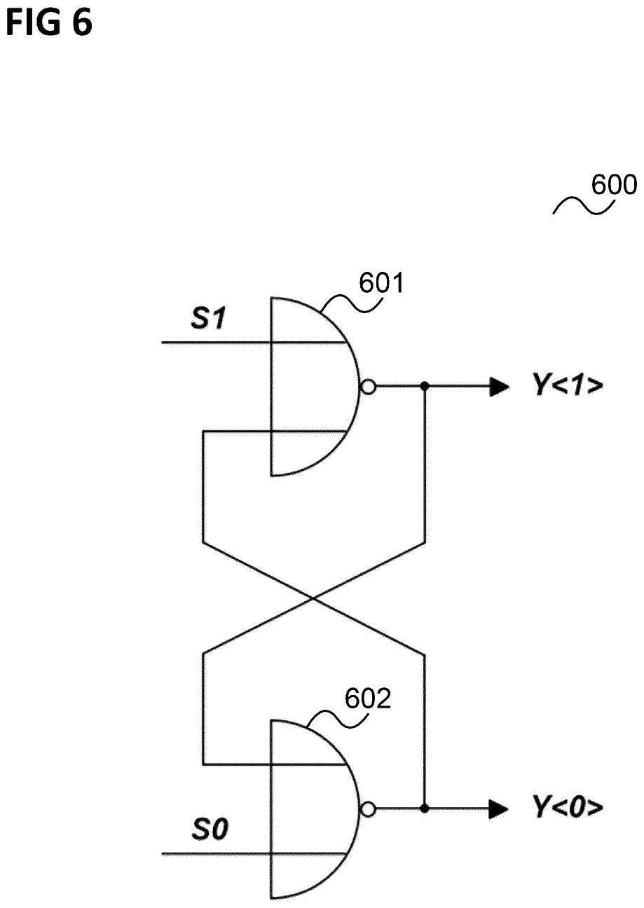

FIG. 6 shows an RS flip-flop 600 based on two NOR gates 601, 602. If the RS flip-flop 509 is realized in this way, both paths are precharged to the high logic level (by the control circuit 508) and a falling edge is sent as input signal. If the top input (S1) switches first, then the output of the RS flip-flop is Y<1>=1, Y<0>=0, otherwise the output is Y<1>=0, Y<0>=1. For other realizations (e.g. a realization based on NAND gates), the conditions may be reversed.

In the case of two delay stages, as in the example of FIG. 5, the results of the two determinations (i.e. measurements) of which delay element is the faster can be XOR-combined to determine the control bit value for the POC circuit element 500:

If the same delay element is the faster one both times (i.e. both Δτ₁ and Δτ₂ are negative or both Δτ₁ and Δτ₂ are positive), then the control bit value corresponds to the setting of the multiplexer 507 in which it switches the paths “straight” through (e.g. control bit value 0) and otherwise (Δτ₁ and Δτ₂ have different signs) corresponds to the setting of the multiplexer 507 in which it switches the paths through “crosswise” (e.g. control bit value 1).

Therefore, the control bit value can be set e.g. simply by XOR of the two values of Y<1> for the two measurements. If there are more than two delay stages, this is possible in an analogous manner (by appropriate treatment of successive delay stages).

Thus, it is possible to determine the control bit values and thus the password for all POC circuit elements 500 of the POC source 105. This can then be stored in the respective chip (e.g. in memory 103) or else outside. It should be noted that knowing the password does not by itself provide any information about the POC value. An attacker who can trigger generation of a POC value but does not know the password (that is to say uses a random password) is then able on average to generate approximately three of four bits of the POC value correctly. Compared to POC value generation without the described password mechanism, this increases security considerably, because in this case all bits of the POC value would be generated correctly.

After the registration described above, the POC value can be retrieved by setting the multiplexers of the POC circuit elements in accordance with the control bits of the password which is stored on the chip or externally. In the case of two stages, the total delay difference of the two paths of the POC circuit element is

Δτ=+/−{|Δτ₁|+|Δτ₂|}=Δτ₁+/−Δτ₂, where the delays add up constructively because the control bits were chosen accordingly. This results in high robustness with respect to voltage fluctuations and temperature fluctuations or less outlay for error correction (e.g. less auxiliary data and also less outlay for generating auxiliary data). Due to the high robustness it is also possible, as described above, to regard a POC value with a high number of errors as unauthorised POC value generation (with incorrect password) and a verification circuit which is set up to detect this can trigger an alarm or deactivate functionalities of the respective chip in such a case.

In addition to the use of Schmitt triggers as delay elements and, correspondingly, pairs of Schmitt triggers for delay stages, other delay elements or delay stages can also be used, e.g.:

Delay stages consisting of two read amplifiers or a plurality of read amplifiers that are connected in series.

Tie cells, i.e. circuits with at least one p-channel FET and at least one n-channel FET in each case, which keep one another in a steady state in that they switch one another on, and which are precharged to an inverse state. The inverse state is inverse to the steady state in the sense that the FETs are switched off. Whichever of two TIE cells reaches its steady state from the precharged state first (triggered by a corresponding level change) is the delay element with the lower delay.

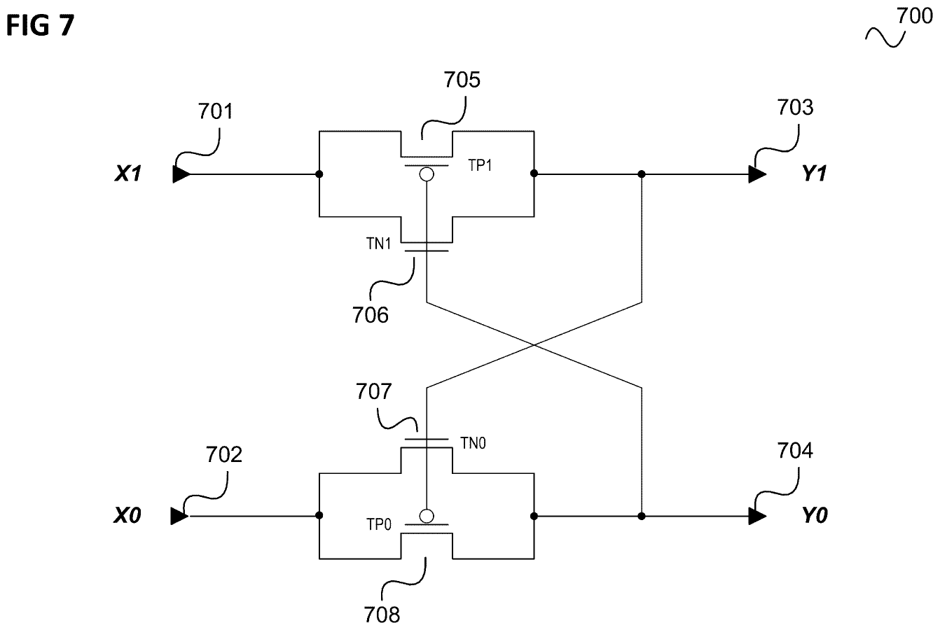

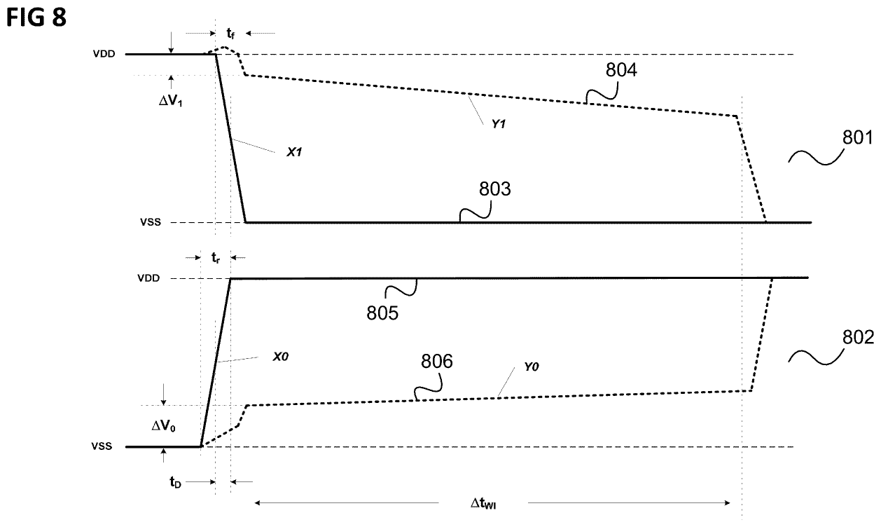

Differential feedback transfer gates, as described below with reference to FIGS. 7 and 8.

Other delay elements which have satisfactory sensitivity with respect to process fluctuations and which may be combined to form pairs (also even more than two) to form a delay stage with two (or more) paths with different delay.

FIG. 7 shows a transmission gate 700, also referred to as a differential feedback transfer gate (DFTG).

The transmission gate 700 has a first input node 701 designated with X1, a second input node 702 designated with X0, a first output node 703 designated with Y1 and a second output node 704 designated with Y0.

A first p-channel field effect transistor 705 (designated as TP1) is connected between the first input node 701 and the first output node 703. A first n-channel field effect transistor 706 (designated as TN1) is connected in parallel to that, between the first input node 701 and the first output node 703.

A second n-channel field effect transistor 707 (designated as TN0) is connected between the second input node 702 and the second output node 704. A second p-channel field effect transistor 708 (designated as TP0) is connected in parallel to that, between the second input node 702 and the second output node 704.

The first output node 703 is fed back to the gates of the second n-channel field effect transistor 707 and the second p-channel field effect transistor 708.

The second output node 704 is fed back to the gates of the first p-channel field effect transistor 705 and the first n-channel field effect transistor 706.

The following assumes that the logical value 0 corresponds to the lower supply potential VSS and that the logical value 1 corresponds to the upper supply potential VDD.

Furthermore, it is assumed that the node pairs (X1,X0) and (Y1,Y0) can each assume the two complementary equilibrium states (1,0) and (0,1) and also that switching back and forth takes place between these two states (by means of respectively suitable control from outside by means of (X1,X0) (or (Y1,Y0)), wherein in the mode of operation described below, (X1,X0) form the input node pair and (Y1,Y0) form the output node pair.

As can be seen from FIG. 7, the transmission gate 700 is symmetrically constructed with regard to interchanging nodes X1 and X0 (and also Y1 and Y0), so that it is sufficient without limiting generality to consider the transition of (X1,X0) from (1,0) to (0,1) and the behavior over time of (Y1,Y0), which results from that, at the transition from (1,0) to (0,1).

FIG. 8 shows the behavior over time when switching the input node pair (X1, X0) from (1,0) to (0,1).

A first diagram 801 in this case shows the course of the level of X1 in a first curve and the course of the level of Y1 in a second (dashed) curve 804.

A second diagram 802 shows the course of the level of X0 in a third curve 805 and the course of the level of Y0 in a fourth (dashed) curve 806.

In the diagrams 801, 802, time increases from left to right in each case and the level (i.e. the respective node potential) increases from bottom to top in each case, wherein it moves between VSS and VDD in accordance with the assumed logic level.

As illustrated in FIG. 8, the transition of (Y1,Y0) from (1,0) to (0,1) does not take place like that of (X1,X0), i.e. not with switching times tᵣ or t_{f}. The input signals for the input nodes 701, 702 are for example provided by means of standard CMOS gates.

After a short initial phase, during which the first p-channel transistor 705 and the second n-channel transistor 707 are still in strong inversion (SI), and after the potential of Y1 has decreased by ΔV₁ and that of Y0 has increased by ΔV₀, all four transistors 705, 706, 707, 708 are in weak inversion (WI) and therefore operate below their respective threshold voltage (the threshold voltages are designated as Vth(P1), Vth(N1), Vth(P0), Vth(N0) in accordance with the designations of the transistors).

The comparatively low channel currents associated with that in turn have the consequence that the charges of the electrical (load) capacitances C_{Y} connected to Y1 and Y0 (for example, having the respective gate capacitances of the transistors and capacitances of nodes connected to the transmission gate 700 at the output side) can only be reversed very slowly, so that a much longer time interval Δt_{WI} compared to standard CMOS switching times elapses until the potentials at Y1 and Y0 have reached values that enable the transition from weak inversion to strong inversion of the first n-channel transistor 706 and the second p-channel transistor 708: Y0 is then increased to approximately Vth(N1) and Y1 is decreased to approximately VDD−|Vth(P0)|.

Thus, the result is that a mutual hindrance of the charge transport initially results from the reciprocal negative feedback from Y1 to the gate terminals of the second p-channel transistor 708 and the second n-channel transistor 707 and from Y0 to the gate terminals of the first p-channel transistor 705 and the first n-channel transistor 706 (wherein a capacitive coupling between Y1 and Y0 is also present by means of the gate capacitances of the transistors 705, 706, 707, 708, which is indicated in FIG. 7 by the overshoot of Y1 during t_{f}), that the same negative feedback also means mutual support for the Δt_{WI} ongoing non-equilibrium state (i.e. the phase of weak inversion during which none of transistors 705, 706, 707, 708 is in strong inversion) moving in the direction of the new equilibrium state (in which (Y1,Y0) assumes the state (0,1)) until one of the threshold voltages of the first n-channel transistor 706 or the second p-channel transistor 708 is reached, whereupon the other threshold voltage in each case is then also very quickly exceeded and (Y1,Y0) is immediately set to (0,1).

The DFTG switching processes from (1,0) to (0,1) and from (0,1) to (1,0) are therefore practically exclusively dependent on the weak inversion behavior of the transistors 705, 706, 707, 708 (wherein after reaching ΔV₁ or ΔV₀, the first p-channel transistor 705 and the second n-channel transistor 707 contribute only little to the charge reversal of the output nodes 703, 704 due to their source diodes and drain bulk diodes which are then poled in the reverse direction).

In the following, it is assumed that the transistors 705, 706, 707, 708 are MOSFETs (Metal Oxide Semiconductor Field Effect Transistors).

For the channel current e.g. of an nMOS transistor (i.e. n-channel MOSFET) in the weak inversion range, the following applies

$$i .$$

$${I}_{DS} = 2 μ \cdot {C}_{ox} \frac{W}{L} {( \frac{kT}{e} )}^{2} {e}^{e \cdot \frac{{V}_{GS} - {V}_{th}}{kT}} \{ {e}^{e \cdot \frac{- {V}_{SB}}{kT}} - {e}^{e \cdot \frac{- {V}_{DB}}{kT}} \} ,$$

with the mobility μ, the specific gate capacitance Cₒₓ, the width W and the length L of the gate, the Boltzmann constants k, the temperature T, the elementary charge e, the input voltage Vₜₕ and also the voltages V_{GS}, V_{SB} and V_{DB} between gate and source, source and bulk (substrate) or drain and bulk.

Therefore, exponential dependences of the channel current on T and Vₜₕ and also on the terminal voltages V_{GS}, V_{SB} and V_{DB} prevail, quite in contrast to the linear or quadratic dependences in the range of strong inversion.

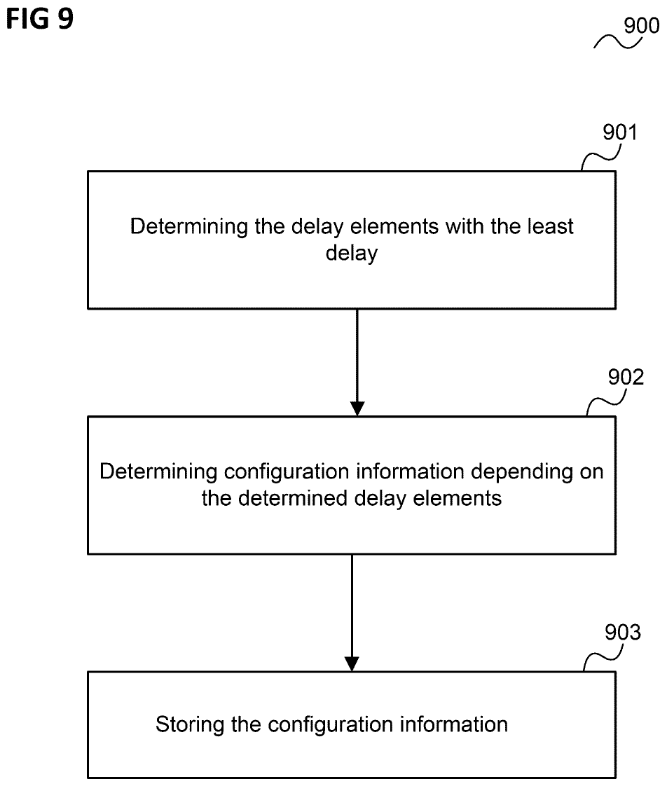

In summary, according to various aspects, a method is provided, as is illustrated in FIG. 9.

FIG. 9 shows a flowchart 900 which illustrates a method for providing configuration information for generating physically obfuscated information (e.g. configuration information, secrets or POC values) on a chip.

The chip has a quantity of (physically-obfuscated-value-generating sub-) circuits (also referred to above as POC circuit elements) each with a plurality of delay stages, wherein each delay stage has at least two delay elements.

In 901, for each of the circuits and for each delay stage (of the respective circuit), it is determined which of the delay elements of the delay stage has the least delay among the delay elements of the delay stage. In the case of two delay elements per delay stage, this is equivalent to determining which of the delay elements of the delay stage has the higher delay. If there are more than two delay elements per delay stage, the order of the delays can also be determined, but that would require increased circuit outlay, since a pair-wise comparison of the delays must then take place.

In 902, configuration information is determined depending on the determined delay elements, which configuration information specifies a configuration of the circuit for each of the circuits, in which the delay elements of different (i.e. not the same) delay stages are connected in series in such a way that at least one path is formed (e.g. by means of the determined delay elements) from an input of the circuit to an output of the circuit (e.g. so that the delay elements form a path that in each delay stage leads through the delay element having the least delay among the delay elements of the delay stage; in the case of two delay elements per stage, this is equivalent to configuring the circuit such that the delay elements with the higher delay likewise form a path).

In 903, the determined configuration information is stored.

In other words, according to various aspects, chains are formed from delay elements so that the POC value generation is as robust as possible, in particular in that configuration information is determined in such a way for example that the delays of the delay elements are superimposed constructively (highest delays with the highest delays and lowest delays with the lowest delays).

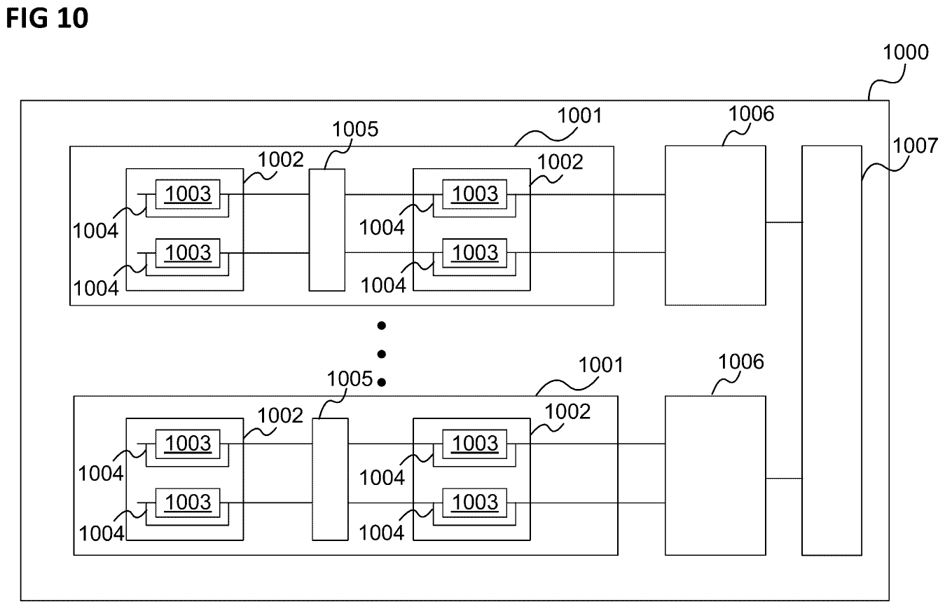

FIG. 10 shows a chip 1000 according to one aspect.

The chip 1000 has a quantity of (physically-obfuscated-value-generating sub-) circuits 1001 (also referred to above as POC circuit elements) each with a plurality of delay stages 1002, wherein each delay stage 1002 has at least two delay elements 1003.

Each of the circuits 1001 has a bypass 1004 of the delay element 1003 for each delay element 1004 (by means of which bypass the delay element can be bypassed when propagating a signal from an input of the delay stage to an output of the delay stage).

Each of the circuits 1001 has at least one connection circuit 1005 which is arranged and set up in such a way that it connects the delay stages 1002 to form a chain of delay stages 1002, which forms a plurality of paths through the circuit 1001.

The chip 1000 additionally has a detection circuit 1006 for each of the circuits 1001, which detection circuit is set up to detect which of the plurality of paths of the circuit 1001 propagates a signal faster.

The chip 1001 additionally has a physically-obfuscated-value-generating circuit 1007 which is set up to generate physically obfuscated information depending on which paths propagate the signals faster (i.e. to generate the physically obfuscated information using the outputs of the detection circuits 1006).

Various exemplary aspects are specified below.

Exemplary aspect 1 is a method as described with reference to FIG. 9.

Exemplary aspect 2 is a method according to exemplary aspect 1, wherein in the configuration of the circuit specified by the configuration information, the delay elements are connected in series in such a way that respectively faster and respectively slower delay elements of the different delay stages are connected in series.

Exemplary aspect 3 is a method according to exemplary aspect 1 or 2, wherein in the configuration of the circuit specified by the configuration information, the delay elements are connected in series in such a way that a path is formed by means of the determined delay elements from the input of the circuit to the output of the circuit.

Exemplary aspect 4 is a method according to exemplary aspect 1, wherein each circuit has at least one connection circuit, wherein the configuration information specifies a configuration for the at least one connection circuit.

Exemplary aspect 5 is a method according to exemplary aspect 4, wherein the at least one connection circuit is arranged and set up in such a way that it connects the delay stages of the circuit to form a chain of delay stages.

Exemplary aspect 6 is a method according to exemplary aspect 4 or 5, wherein the at least one connection circuit is configurable by means of at least one control signal according to a plurality of configurations, which differ in that the at least one connection circuit connects the delay stages in series in a different way in terms of which delay elements of the different delay stages follow one another.

Exemplary aspect 7 is a method according to exemplary aspect 6, wherein according to each configuration, a plurality of paths are formed by the delay stages, which each have one delay element per delay stage, and the configurations differ in terms of which delay elements the paths have.

Exemplary aspect 8 is a method according to one of exemplary aspects 4 to 7, wherein the configuration information specifies a configuration of the at least one connection circuit, in which the at least one connection circuit connects the delay elements in such a way that a path from an input of the circuit to an output of the circuit is formed by means of the determined delay elements.

Exemplary aspect 9 is a method according to one of exemplary aspects 1 to 8, wherein each delay element has a bypass of the delay element and the determination of the delay elements with the least delay comprises connecting the delay stages in series to form a plurality of paths and bypassing the delay elements of all delay stages of the circuit except one delay stage, the delay element of which with the least delay should be determined, and detecting the path by which an input signal was propagated fastest.

Exemplary aspect 10 is a method according to exemplary aspect 9, wherein, for each delay element, the delay of the bypass has a lower dependence on supply voltage and/or temperature than the delay element.

Exemplary aspect 11 is a method according to exemplary aspect 9 or 10, wherein, for each delay element, the bypass has a lower delay than the delay element.

Exemplary aspect 12 is a method according to one of exemplary aspects 1 to 11, wherein the chip is provided with a physically-obfuscated-value-generating circuit, by means of which, depending on outputs of the circuits, physically obfuscated information is generated.

Exemplary aspect 13 is a method according to exemplary aspect 12, wherein the physically-obfuscated-value-generating circuit is set up to generate the physically obfuscated information depending on which paths of a plurality of paths of the circuits propagate the signals faster.

Exemplary aspect 14 is a method according to one of exemplary aspects 1 to 13, comprising storing the configuration information in a non-volatile memory of the chip.

Exemplary aspect 15 is a method according to one of exemplary aspects 1 to 14, comprising storing the configuration information outside the chip.

Exemplary aspect 16 is a method according to exemplary aspect 15, comprising deleting the configuration information from the chip.

Exemplary aspect 17 is a method for generating physically obfuscated information on a chip, comprising providing configuration information according to one of exemplary aspects 1 to 16, configuring each circuit according to the configuration information, propagating signals through each circuit and generating physically obfuscated information depending on which paths of a plurality of paths of the circuits propagate the signals faster.

Exemplary aspect 18 is a method according to exemplary aspect 17, comprising generating one bit of the physically obfuscated information for each of the circuits, depending on which path of a plurality of paths of the circuit propagates the signal faster.

Exemplary aspect 19 is a chip as described with reference to FIG. 10.

Exemplary aspect 20 is a chip according to exemplary aspect 19, further comprising a control circuit for each of the circuits, which is set up to control the circuit in such a way that the delay elements of all delay stages of the circuit except one delay stage are bypassed, and to detect the path by which an input signal was propagated fastest.

Although the aspects of the disclosure been shown and described primarily with reference to specific aspects, it should be understood by those familiar with the technical field that numerous modifications can be made thereto with regard to configuration and details, without departing from the essence and scope of the disclosure as defined by the claims hereinafter. The scope of the aspects of the disclosure are therefore determined by the appended claims, and the intention is for all modifications to be encompassed which come under the literal meaning or the scope of equivalence of the claims.

### REFERENCE SIGNS

100 Chip card

### 101 Carrier

102 Chip card module
103 Non-volatile memory

### 104 CPU

105 POC source
106 POC module
200 Schmitt trigger
201,202 pMOSFETs
203,204 nMOSFETs
205 High supply potential
206 Low supply potential

### 207 Input

208 Connection node
209 pMOSFET
210 nMOSFET
300 POC circuit element
301, 302 Delay stages
303-306 Delay elements

### 307 Multiplexer

400 Delay circuit
401 Delay element
402 Bypass element
500 POC circuit element
501, 502 Delay stages
503-506 Delay circuits

### 507 Multiplexer

508 Control circuit
509 RS flip-flop
600 RS flip-flop
601, 602 NOR gates

### 700 DFTG

701,702 Input nodes
703, 704 Output nodes
705 p-channel FET
706, 707 n-channel FET
708 p-channel FET

### 801-802 Diagrams

### 900 Flowchart

901-903 Sequence steps

### 1000 Chip

### 1001 Circuits

1002 Delay stages
1003 Delay elements

### 1004 Bypasses

1005 Connection circuits
1006 Detection circuits
1007 Physically-obfuscated-value-generating circuit

1. A method for providing configuration information for generating physically obfuscated information on a chip having a quantity of circuits, which each have a plurality of delay stages, and each delay stage has at least two delay elements, wherein the method comprises:
determining, for each of the circuits, for each delay stage, which of the delay elements of the delay stage has the least delay among the delay elements of the delay stage;
determining configuration information depending on the determined delay elements, which configuration information specifies a configuration of the circuit for each of the circuits, in which the delay elements of different delay stages are connected in series in such a way that at least one path from an input of the circuit to an output of the circuit is formed; and
storing the determined configuration information.

2. The method as claimed in claim 1, wherein in the configuration of the circuit specified by the configuration information, the delay elements are connected in series in such a way that respectively faster and respectively slower delay elements of the different delay stages are connected in series.

3. The method as claimed in claim 1, wherein in the configuration of the circuit specified by the configuration information, the delay elements are connected in series in such a way that a path is formed using the determined delay elements from the input of the circuit to the output of the circuit.

4. The method as claimed in claim 1, wherein each circuit has at least one connection circuit, and the configuration information specifies a configuration for the at least one connection circuit.

5. The method as claimed in claim 4, wherein the at least one connection circuit is arranged and set up in such a way that it connects the delay stages of the circuit to form a chain of delay stages.

6. The method as claimed in claim 4, wherein the at least one connection circuit is configurable by means of at least one control signal according to a plurality of configurations, which differ in that the at least one connection circuit connects the delay stages in series in a different way in terms of which delay elements of the different delay stages follow one another.

7. The method as claimed in claim 6, wherein according to each configuration, a plurality of paths are formed by the delay stages, which each have one delay element per delay stage, and the configurations differ in terms of which delay elements the paths have.

8. The method as claimed in claim 4, wherein the configuration information specifies a configuration of the at least one connection circuit, in which the at least one connection circuit connects the delay elements in such a way that a path from an input of the circuit to an output of the circuit is formed by means of the determined delay elements.

9. The method as claimed in claim 1, wherein each delay element has a bypass of the delay element and the determination of the delay elements with the least delay comprises connecting the delay stages in series to form a plurality of paths and bypassing the delay elements of all delay stages of the circuit except one delay stage, the delay element of which with the least delay should be determined, and detecting the path by which an input signal was propagated fastest.

10. The method as claimed in claim 9, wherein, for each delay element, the delay of the bypass has a lower dependence on supply voltage and/or temperature than the delay element.

11. The method as claimed in claim 9, wherein, for each delay element, the bypass has a lower delay than the delay element.

12. The method as claimed in claim 1, wherein the chip is provided with a physically-obfuscated-value-generating circuit, by means of which, depending on outputs of the circuits, physically obfuscated information is generated.

13. The method as claimed in claim 12, wherein the physically-obfuscated-value-generating circuit is configured to generate the physically obfuscated information depending on which paths of a plurality of paths of the circuits propagate signals faster.

14. The method as claimed in claim 1, further comprising storing the configuration information in a non-volatile memory of the chip.

15. The method as claimed in claim 1, further comprising storing the configuration information outside the chip.

16. The method as claimed in claim 15, further comprising deleting the configuration information from the chip.

17. A method for generating physically obfuscated information on a chip, comprising:
providing configuration information as claimed in claim 1;
configuring each circuit according to the configuration information;
propagating signals through each circuit; and
generating physically obfuscated information depending on which paths of a plurality of paths of the circuits propagate the signals faster.

18. The method as claimed in claim 17, further comprising generating one bit of the physically obfuscated information for each of the circuits, depending on which path of a plurality of paths of the circuit propagates the signal faster.

19. A chip, comprising:
a plurality of circuits, each with a plurality of delay stages, wherein each delay stage has at least two delay elements,
wherein each of the circuits has a bypass of the delay element for each delay element, and wherein each of the circuits has at least one connection circuit which is arranged and set up in such a way that it connects the delay stages to form a chain of delay stages, which forms a plurality of paths through the circuit;
a detection circuit for each of the circuits, which detection circuit is configured to detect which of the plurality of paths of the circuit propagates a signal faster;
a physically-obfuscated-value-generating circuit which is configured to generate physically obfuscated information depending on which paths propagate the signals faster.

20. The chip as claimed in claim 19, further comprising a control circuit for each of the circuits, which is configured to control the circuit in such a way that the delay elements of all delay stages of the circuit except one delay stage are bypassed, and to detect the path by which an input signal was propagated fastest.
